(19) United States
(12) Patent Application Publication
(10) Pub. No.: US 2026/0203231 A1
(43) Pub. Date: Jul. 16, 2026

(54) DYNAMIC RESIZING OF PROBABILISTIC DATA STRUCTURES FOR USE IN CACHE ADMISSION POLICIES

(71) Applicant: Seagate Technology LLC, Fremont, CA (US)

(72) Inventors: Heonjung Kim, Shugart (SG); Zi Jian Wee, Shugart (SG); Hock Soon Lim, Shugart (SG); Nidhi Narsingh Chaudhary, Shugart (SG); Frederick Castro, Shugart (SG)

(21) Appl. No.: 19/025,321

(22) Filed: Jan. 16, 2025

(51) Int. Cl. G06F 12/0877

(52) U.S. Cl. CPC G06F 12/122; G06F 2212/60

(57) ABSTRACT

Described are tiered data storage systems and methods for distributing data into high performance and low performance tiers based on an estimation of the frequency of use. Probabilistic data structures such as counting bloom filters may be used to provide a frequency of use estimation. However, the size of the probabilistic data structure may not be appropriate for all workloads. Accordingly, the size of probabilistic data structures can be dynamically adjusted based on workload, thus ensuring that the probabilistic data structure is large enough to be effective in frequency of use estimations, but not so large as to result in excess memory overhead. The efficiency of the probabilistic data structure may be determined by changes in request pattern as indicated by a unique virtual block address (VBA) ratio, as well as changes in block request hit rate.

### TECHNICAL FIELD

The disclosure relates to systems and methods for tiered data storage.

### SUMMARY

In accordance with various aspects, the present disclosure describes methods for use with tiered data storage systems that includes a cache memory managed by a cache admission policy. Such methods include admitting and evicting data items from the cache on a least frequently used (LFU) basis, and in which a probabilistic data structure having a current size provides the LFU estimation. A change parameter is then developed that is indicative of a current LFU estimation efficiency during servicing of a current plurality of data requests compared to a previous LFU estimation efficiency during servicing of a previous plurality of data requests. An updated size for the probabilistic data structure is then determined based on the change parameter, and the updated size for the probabilistic data structure is set.

In certain aspects, the probabilistic data structure is a counting bloom filter. In certain aspects, the methods include maintaining and running multiple counting bloom filters each having a different size such that setting the current size for the probabilistic data structure involves selecting one of the multiple counting bloom filters.

In certain aspects, the LFU estimation efficiency is based on a data request pattern such as a change in unique virtual block addresses. In certain aspects, the LFU estimation efficiency is based on a cache hit rate.

In certain aspects, the plurality of data requests takes place over a window of size W, and the size of the probabilistic data structure is based on the window size W.

In accordance with various aspects, the present disclosure describes methods for use with a tiered data storage system that includes a cache memory managed by a cache admission policy. Such methods include maintaining and running multiple counting bloom filters each having a different size, admitting and evicting data items from the cache on an LFU basis, where LFU estimation is provided by a selected one of the multiple counting bloom filters, determining an LFU estimation efficiency over a plurality of data requests, and selecting the selected one of the multiple counting bloom filters responsive to determining the LFU estimation efficiency.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic diagram of a tiered storage system that may utilize dynamic resizing of probabilistic data structures in accordance with aspects of the present disclosure.

FIG. 2 is a flow chart showing steps that may be performed during the resizing of probabilistic data structures in accordance with aspects of the present disclosure.

### DETAILED DESCRIPTION

The present disclosure relates to tiered data storage systems that manage the admission and eviction of data from a data cache based on an estimation of the frequency of use, also referred to as data hotness. As storage systems continue to scale, the demand for efficient data management strategies increases as does the demand for storage solutions that balance performance and cost appropriately. This has led to the development of multi-tiered storage architectures, which include fast tiers (such as solid state storage arrays) and slow tiers (such as hard disk drive storage arrays) whose characteristics are leveraged based on the access patterns and performance requirements of the data. A caching algorithm may utilize a cache admission policy to assist in the distribution of the data to the appropriate tier, the efficient and accurate determination of which is desirable.

Cache admission policies may use a counting bloom filter (CBF), or other probabilistic data structure, to estimate which data items are the least frequently used (LFU) among the data items being considered for cache admission and eviction. In accordance with the present disclosure, the size of the CBF or other probabilistic data structure may be dynamically adjusted, for example based on workload. As the workload changes, the efficiency of the frequency estimations provided by the probabilistic data structure may change, indicating that the size of the probabilistic data structure may be adapted. Efficiency of the frequency estimations may be assessed by calculating a change parameter, such as a change in request pattern as indicated by a unique virtual block address (VBA) ratio, or a change in a block request hit rate. Change parameters that are below a threshold may indicate that the size of the CBF or other probabilistic data structure is larger than necessary, thus resulting in excess memory overhead. Change parameters that are above a threshold may indicate that the size of the CBF or other probabilistic data structure is insufficient to provide an effective hit rate. The size of the CBF or other probabilistic data structure may be adjusted up or down accordingly. Throughout this document, the terms ‘CBF’ and ‘probabilistic data structure’ are used interchangeably, which will be understood without loss of generality.

In certain aspects, methods of the present disclosure may be used to dynamically change the size of CBFs, thus promoting better frequency estimation in storage tiering that utilizes an LFU-based cache admission policy such as TinyLFU. While TinyLFU includes frequency tracking and decision-making that can improve cache hit rates, implementations of TinyLFU to date have only used a fixed size CBF. In the context of storage tiering where data access patterns and workloads can change dynamically, the reliance on a statically sized CBF limits the adaptability of the cache admission policy. As the workload changes dynamically, the use of a fixed size CBF can lead to performance bottlenecks, thereby increasing latency in read/write operations.

In accordance with various aspects of the present disclosure, the size of a CBF or other probabilistic data structure may be adapted in response to changes in workload patterns. By monitoring parameters such as unique VBA ratios and/or cache hit rates, the system may determine whether the current CBF configuration is no longer optimal, and in response dynamically change the size of the CBF to better accommodate anticipated access patterns. In certain implementations, interchangeable CBFs of various sizes may be defined and then selected for use based on changes in data access patterns, thereby maintaining performance gains. In certain aspects, the present disclosure includes maintaining and running multiple CBFs of different sizes concurrently in a tiered storage system, and then selecting which of the multiple CBFs to use responsive to the development of a change parameter. In certain aspects, the present disclosure includes calculating a unique VBA ratio for use as a metric in tiered storage systems to aid in the selection of CBF size, thus facilitating CBF dynamic adaptation to changing workloads. In certain aspects, the present disclosure also includes calculating a cache hit rate representing the percentage of block requests that were served out of the total number of requests. Such a cache hit rate may be used to facilitate the dynamic selection of CBF size.

Reference will now be made to the drawings, which depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar. It will also be appreciated that the drawings are meant to illustrate certain aspects and arrangements of features in a way that contributes to their understanding and are not meant to be scale drawings that accurately represent size or shape of elements.

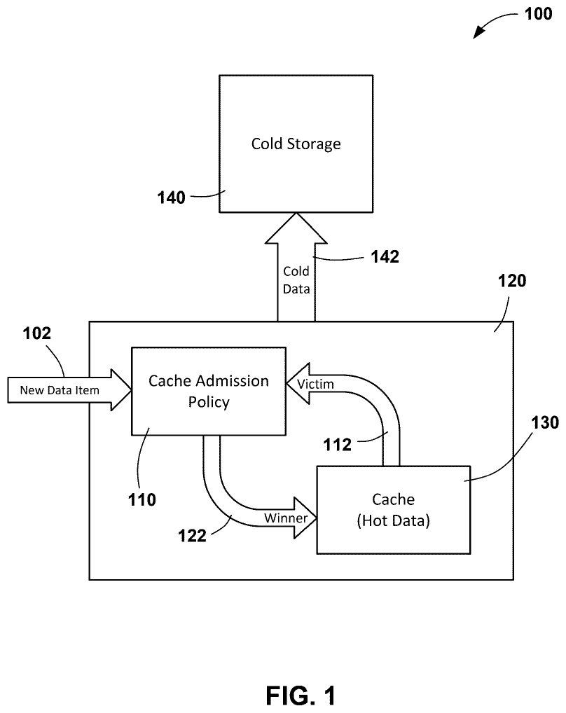

FIG. 1 schematically shows certain aspects of an example tiered, or hybrid, storage system 100. Tiered storage system 100 may include a high-performance storage module 120 that is configured to receive new data storage requests 102 by a cache admission policy 110. The cache admission policy 110 arbitrates between a cache victim 112 and a new data item 102 for admission and eviction from the cache. Cache 130 decides on the cache victim 112 using arbitrary caching techniques such as least recently used, or LRU. Cache admission policy 110 then uses LFU techniques to select which of new data item 102 and the victim 112 to admit and evict. Data items admitted to the cache are termed winners 122, and evicted data items are considered cold data 142. To aid in determining least frequently used, the cache admission policy 110 may use a probabilistic data structure such as a CBF for estimation, the size of which may be adjusted to accommodate different workloads in accordance with various aspects of the present disclosure. Cold data 142 may be migrated into a cold storage module 140, such as a hard disk drive array. Cache 130 may be any non-volatile data storage medium that is capable of high-performance data retrieval, such as NAND flash or other solid state storage. Moreover, additional high-performance, medium-performance, and low-performance data storage modules (not shown) may also be included in the tiered storage system 100.

One of the fundamental challenges in storage tiering is optimizing data placement and access to ensure that frequently used data remains in the high-performance tiers while rarely accessed data is migrated to lower-performance tiers. There are various cache admission policies to accomplish this, including TinyLFU. However, the need for cache admission policies to keep track of the frequency of the requested items can result in a large memory overhead. Because of this, CBFs have emerged as useful tools. CBFs are space-efficient probabilistic data structures designed to test whether an element is a member of a set, while also incorporating a counting mechanism that provides for the insertion and deletion of elements. CBFs have proven essential in storage tiering by enabling fast, low-overhead membership queries that help to optimize data movement between tiers.

The size of CBFs is predetermined based on the number of elements to be stored. However, the optimal number of elements to be stored may not be known in advance or may change with changing workloads. Using a CBF size that is too large may end up wasting space, while using a CBF size that is too small may end up yielding a poor hit rate for block storage requests. In systems and methods of the present disclosure, dynamic resizing mechanisms may be employed that adapt or otherwise select the size of the CBF in response to changes in workload patterns. By monitoring unique VBA ratios, for example, the system can determine if and when the current CBF configuration is no longer optimal, and in response dynamically change the size of the CBF to better accommodate the upcoming, anticipated access patterns. Unique VBAs may be calculated over a plurality of data requests such that a unique VBA ratio can be calculated using a current number of unique VBAs over a current plurality of data requests as compared to a previous number of unique VBAs over a previous plurality of data requests.

CBFs are an extension of traditional bloom filters which are used to test whether an element is a member of a set using simple binary bits. When a CBF is initialized, an array of a predetermined number of slots is created. These slots are initially set to zero before any elements are added into the array. When an element is to be added, a hash function is used to convert the element into a unique identifier of fixed length. Since each element will be assigned to multiple slots in the CBF, they will pass through multiple hashing functions to find the corresponding hash code in the CBF. In the process of adding an element, the “keys” of the element are found using remainders of the hash code divided by the array size of the CBF. The counts are then incremented (for example, increased by one) in the respective key slots. To remove an element, the same steps are carried out but this time decrementing the counts (for example, decreasing by one). In an LFU-based cache admission policy that utilizes a CBF as a lightweight frequency estimator to determine the approximate frequency of items, a lookup of the CBF is performed by hashing the item and obtaining the keys. These keys are then used to check the values in the CBF to retrieve the estimated frequency of the item. As mentioned, in the context of hybrid storage tiering, data access patterns and workloads can change dynamically. Thus, as appreciated in the present disclosure, using a fixed size for the CBF limits the adaptability of cache admission and eviction, leading to performance bottlenecks and increasing latency in read/write operations.

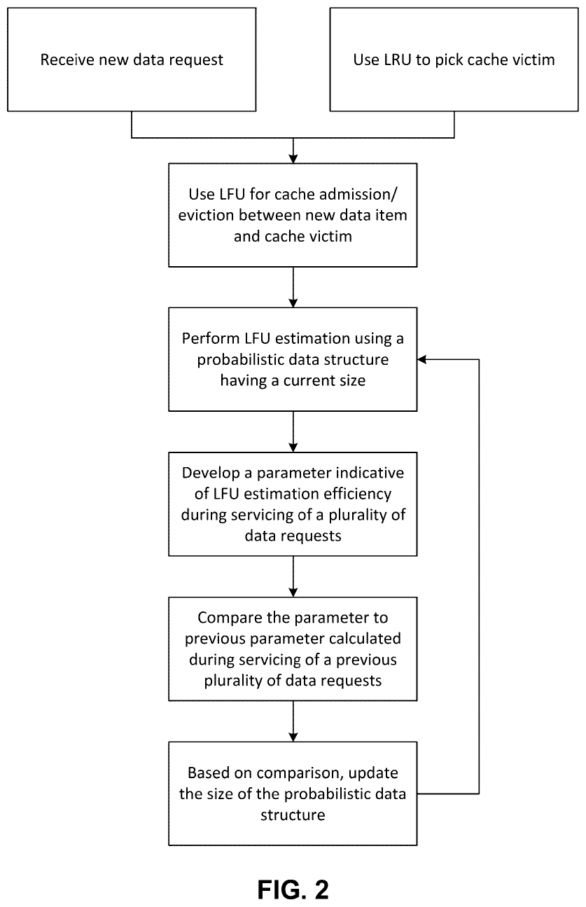

FIG. 2 shows an example flow chart of steps involved in adjusting the size of a probabilistic data structure used to estimate frequency in an LFU-based cache admission policy. First, a victim is selected from cache by employing a least recently used (LRU) or other arbitrary technique. Then, LFU is used for cache admission and eviction between a new data item and the cache victim. The LFU estimation may be made using a probabilistic data structure (such as a CBF) having a current size. The current size may be a default size or a previously selected size. A parameter indicative of a cache hit rate may be developed during the servicing of a plurality of data requests, for example over a pre-determined number of requests (for example, 10,000 requests). The parameter may be compared to a parameter calculated for the servicing of a previous plurality of data requests, thereby determining an amount of change in the hit rate parameter. Based on this comparison, the size of the probabilistic data structure can be updated, with the updated size becoming the new current size.

The size of the CBF may affect the performance of the cache admission policy. A smaller CBF size works more effectively with hot data, whereas a larger CBF size is better suited for cold data. In accordance with the present disclosure, the size of the CBF can be dynamically adjusted based on the unique VBA ratio or other such parameter. When deciding on whether to map block storage requests to the fast (hot) tier or slow (cold) tier, the unique VBA ratio, R_{VBA}, may be calculated as follows: R_{VBA}=N/ (Total Entries), where N is the number of unique VBAs, and Total Entries is the count of all requests.

To keep track of changes in R_{VBA}, a window W may be used, where W spans a number of requests (for example, 10,000 requests). A number of CBFs of varying sizes may also be defined based on the widow size W. For example, five different CBFs may be defined with the following sizes: CBF1 size is set at 0.1×W, CBF2 size is set at 0.5×W, CBF3 size is set at W, CBF4 size is set at 5×W, and CBF5 size is set at 10×W.

Given a number of requests received during an initial window, W₀, the following procedure may be implemented. Calculate R_{VBA} for W₀. Hash the requests within W₀ across all of the CBFs. Set the current CBF, CBF_{current}, as the median sized CBF. Use CBF_{current} for eviction and admission. For the next set of requests at iteration i, do the following:
Begin
   a. Hash the requests within Wᵢ across all the CBFs
   b. Calculate R_{VBA} at Wᵢ
   c. Calculate the percentage change (Δ%) in R_{VBA} between Wᵢ and Wᵢ₋₁
   d. If Δ%>upper-threshold, replace CBF_{current} with a CBF of larger size, if it exists
   e. If Δ%<lower-threshold, replace CBF_{current} with a CBF of smaller size, if it exists
   f. Use CBF_{current} for eviction and admission
End

In this way, to efficiently and dynamically change the CBF in use, windows of requests may be utilized, during which the changes in request patterns are monitored. The unique VBA ratios serve as a marker for these request patterns, and any change in R_{VBA} of a large enough magnitude indicates that the utility of the CBF used in the previous window might not be well-tailored for the new request pattern. By varying the CBF size based on R_{VBA}, the performance of admission policies like TinyLFU can be adapted to the changes in data patterns.

To evaluate the performance of the CBFs, a hit rate may also be calculated to determine the percentage of block requests that were served out of the total number of requests. Hit rate may be used as an alternative, or in addition, to using unique VBA ratios. Hit rate may be calculated, for example, according to: Hit Rate=100×(Number of Hits)/(Total Requests), where Number of Hits is the total count of block requests served during a window, and Total Requests is the count of all block requests made during that window. For a particular window Wᵢ, the requests may be hashed across all CBFs and the hit rates may be calculated for each CBF. By comparing the hit rates across all the different CBFs, the CBF with the highest hit rate may be used as the CBF for window Wᵢ.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (for example, all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. A method for use with a tiered data storage system that includes a cache memory managed by a cache admission policy, the method comprising:
admitting and evicting data items from the cache on a least frequently used (LFU) basis, where a probabilistic data structure having a current size provides an LFU estimation;
developing a change parameter indicative of a current LFU estimation efficiency during servicing of a current plurality of data requests compared to a previous LFU estimation efficiency during servicing of a previous plurality of data requests;
determining an updated size for the probabilistic data structure based on the change parameter; and
setting the current size for the probabilistic data structure at the updated size.

2. The method of claim 1, wherein the probabilistic data structure is a counting bloom filter.

3. The method of claim 2, further comprising maintaining and running multiple counting bloom filters each having a different size.

4. The method of claim 3, wherein setting the current size for the probabilistic data structure comprises selecting one of the multiple counting bloom filters.

5. The method of claim 1, wherein the LFU estimation efficiency is based on a data request pattern.

6. The method of claim 5, wherein the data request pattern is a change in unique virtual block addresses.

7. The method of claim 1, wherein the LFU estimation efficiency is based on a cache hit rate.

8. The method of claim 1, wherein the plurality of data requests takes place over a window of size W.

9. The method of claim 8, wherein the size of the probabilistic data structure is based on the window size W.

10. A method for use with a tiered data storage system that includes a cache memory managed by a cache admission policy, the method comprising:
maintaining and running multiple counting bloom filters each having a different size;
admitting and evicting data items from the cache on a least frequently used (LFU) basis, where LFU estimation is provided by a current counting bloom filter selected from the multiple counting bloom filters;
determining an LFU estimation efficiency over a plurality of data requests;
selecting an updated counting bloom filter from the multiple counting bloom filters responsive to determining the LFU estimation efficiency; and
replacing the current counting bloom filter with the updated counting bloom filter.

11. The method of claim 10, wherein the plurality of data requests defines a window size W.

12. The method of claim 11, wherein the size of each of the multiple counting bloom filters is based on W.

13. The method of claim 12, wherein the multiple counting bloom filters include five counting bloom filters, two of the five counting bloom filters having sizes that are a fraction of W, two of the five counting bloom filters having sizes that are a multiple of W, and one of the five counting bloom filters having a size equal to W.

14. The method of claim 10, wherein when the LFU estimation efficiency indicates that the current counting bloom filter is too large, then selecting a smaller one of the multiple counting bloom filters as the updated counting bloom filter if a smaller one is available, when the LFU estimation efficiency indicates that the current counting bloom filter is too small, then selecting a larger one of the multiple counting bloom filters as the updated counting bloom filter if a larger one is available, and otherwise selecting the current counting bloom filter as the updated counting bloom filter.

15. A tiered data storage system configured to service data requests under a workload, the tiered data storage system comprising:
a low performance storage tier; and
a high performance storage tier that includes a cache memory managed by a cache admission policy, the cache admission policy configured to:
arbitrate between a new data item and a selected cache victim for admission to and eviction from the cache, the arbitration based on a least frequently used (LFU) estimation provided by a probabilistic data structure having a current size; and
adjust the current size of the probabilistic data structure based on characteristics of the workload over a plurality of data requests.

16. The tiered data storage system of claim 15, wherein the characteristics of the workload are determined by developing a change parameter indicative of LFU estimation efficiency.

17. The tiered data storage system of claim 16, wherein the LFU estimation efficiency is based on a data request pattern indicated by a change in unique virtual block addresses.

18. The tiered data storage system of claim 16, wherein the LFU estimation efficiency is based on a cache hit rate.

19. The tiered data storage system of claim 15, wherein the probabilistic data structure is a counting bloom filter.
